(19) United States
(12) Patent Application Publication
(10) Pub. No.: US 2010/0253525 A1
(43) Pub. Date: Oct. 7, 2010

(54) SYSTEMS AND METHODS FOR HUMAN PERFORMANCE AUGMENTATION

(75) Inventor: Jonathan M. Engel, Minneapolis, MN (US)

Correspondence Address: HONEYWELL/S&S;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 11/961,610

(22) Filed: Dec. 20, 2007

(51) Int. Cl. G08B 23/00; H04B 3/36

(52) U.S. Cl. 340/573.1; 340/407.1

(57) ABSTRACT

Systems and methods for human performance augmentation. A method for human performance augmentation includes collecting sensory data using at least one sensor on a user. When sensory data is collected, a processor processes the collected data into actionable situational intelligence. Once processed, the user is alerted through a tactile interface in communication with the processor. The tactile interface provides multimodal stimulation to the user. An example system for human performance augmentation includes at least one microsensor configured to collect sensory data, the microsensor having a processor. The system further includes a tactile interface in communication with at least one microsensor, such that when altered the tactile interface provides multimodal stimulation to the user.

### BACKGROUND OF THE INVENTION

Soldiers in urban combat are increasingly overwhelmed with information on the battlefield. As technology improves, so do the amount of electronic systems that a soldier has access to. For example soldiers have access to navigation screens, voice communication systems, and communication viewers as well as various types of optics. Each of these additional systems may detract from the soldier's situational awareness due to distraction and information overload. A heightened level of situational awareness keeps the soldier alive and brings them home safely. A soldier must always be able to anticipate the enemy and rapidly respond to the identified threat.

Currently soldiers are given many tools to augment their human senses through the modification of incoming signals and then relaying those signals to the appropriate sense. For example when a soldier looks through thermal-imaging binoculars to see in the dark, a visual signal is modified and then shown to the soldier through visible means. Other examples include, but are not limited to the use of a directional microphone or the use of a chemical alarm. These tools fail because each device consumes some or all of the soldier's senses, thus distracting the soldier from his/hers duties.

Another set of tools allows for soldiers to relay information through the use of vibration or electric shock on the skin or the tongue of the soldier. These tools have been used to pass both navigational information and basic tactical squad level hand signal communications. The method, while beneficial, falls short of warning soldiers of threats.

### SUMMARY OF THE INVENTION

Systems and methods for human performance augmentation are disclosed herein. A method for human performance augmentation includes collecting sensory data using at least one sensor on a user. When sensory data is collected, a processor processes the collected data into actionable situational intelligence. Once processed, the user is alerted through a tactile interface in communication with the processor. The tactile interface provides multimodal stimulation to the user.

An example system for human performance augmentation includes at least one microsensor configured to collect sensory data, the microsensor having a processor. The system further includes a tactile interface in communication with at least one microsensor, such that when altered the tactile interface provides multimodal stimulation to the user.

As will be readily appreciated from the foregoing summary, the invention provides an improved system and method for human performance augmentation.

### BRIEF DESCRIPTION OF THE DRAWINGS

The preferred and alternative embodiments of the present invention are described in detail below with reference to the following drawings:

FIG. 1 shows a schematic diagram of a human performance augmentation system formed in accordance with an embodiment of the present invention;

FIG. 2 shows a microsensor(s) in one embodiment;

FIG. 3 shows a front view of a human performance augmentation system shown on a user;

FIG. 4 shows a rear view of a human performance augmentation system shown on a user; and

FIG. 5 shows a plurality of users in signal communication using a human performance augmentation system.

### DETAILED DESCRIPTION OF THE PREFERRED EMBODIMENT

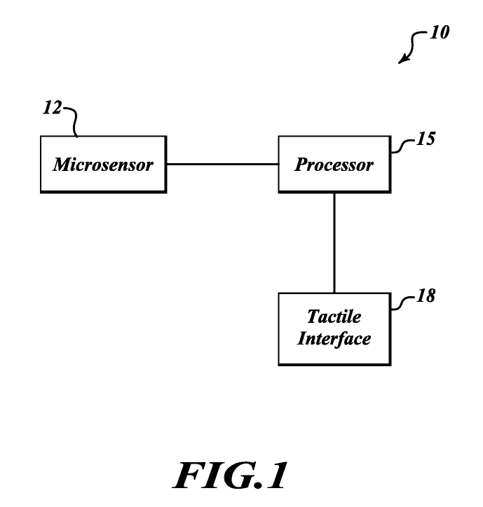

FIG. 1 shows a schematic diagram of a human performance augmentation system 10 formed in accordance with an embodiment of the present invention. The human performance augmentation system 10 detects various threats/conditions in a 360° radius around the user. The system 10 processes the incoming sensor data, analyses it, and determines which information is important, alerting the user through the user's skin in order to not distract the user's primary senses of sight, sound and smell.

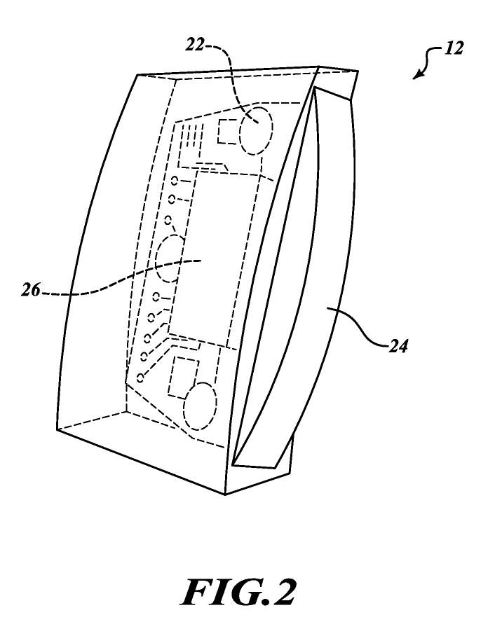

In one embodiment of the invention, a microsensor(s) 12 is used to collect sensor data outside the normal human sensing range/medium. For example, the sensor may collect infra-red or ultra-wideband radio frequency motion data that would allow the wearer to detect threats through barriers opaque to visible light and in a 360 degree range which is far beyond the capabilities of an unaided soldier. The microsensor(s) 12 is coupled to a processor 15 in order to determine the most critical sensory information. The role of the processor is important in that it preferably processes disparate and complex sensor data into useful information and then determines which information is critical for situational awareness in order to avoid information overload. For example, the sensors may detect motion through the walls on both sides of the soldier while additional sensors detect metal weapons, explosive residues, or even whispered commands to attack coming from the right side. The processor combines this data and extracts the pertinent information, determines that the motion on the right side is a threat and then the wearer is alerted. The information is then relayed to a user through a tactile or skin based human machine interface 18. The microsensor(s) 12 preferably detects situational intelligence such as, but not limited to: 360° degree thermal imaging and motion detection, 360° degree wall-penetrating ultra wideband radio frequency motion detection, gunfire acoustic vectoring, tracking of friendly forces, nuclear, biological and chemical detection and tracking, and biometric sensing of the wearer's health and alertness. In one embodiment the microsensor(s) 12 use a bio-metric technique similar to an insect's compound eye to provide full range detection of a threat over 360° degrees. The low-resolution compound eye while having poor image recognition capabilities allows fast and accurate threat and motion detection over a wide field of view when coupled with advanced bio-mimetic signal processing algorithms. The microsensors 12 allow for the wearer to detect and respond to threats from all sides. The microsensor(s) 12 are further described in FIG. 2.

The processor 15 may either be included in the microsensor(s) 12 or can be a stand alone component. The processor 15 receives various sensed information signals from the microsensor(s) 12 and then creates signals for the tactile interface 18. The microsensor(s) 12 is in signal communication with the tactile interface 18. The tactile interface 18 interacts, through actuators, with the skin in a number of ways including, but not limited to vibration, acceleration, pressure, deformation, temperature, texture, thermal conductivity, and/or viscosity. The actuators are varied based on time between each signal and an array of locations of the signal. For example the intensity, location and timing of a vibration can be increased to show a higher threat level. The multimodal interface gives the wearer multiple auxiliary senses that enhance performance but do not degrade situational awareness. The tactile interface 18 includes a number of actuators that are affixed to the skin with an adhesive or optionally integrated into the clothing or armor to allow for close contact with the skin.

FIG. 2 shows the microsensor(s) 12 in one embodiment having multiple sensors. The microsensor(s) 12 as shown contains an acoustic sensor 22, an infrared/ultra wide band (IR/UWB) motion detector 24 and an inertial compensation sensor 26. One embodiment is capable of providing the wearer with 360 degree motion detection using the IR/UWB motion detection sensor as well as allowing detection of the vector direction of incoming gunfire using the acoustic sensor array. In order to reject spurious motion signals from the wearer him/herself the inertial compensation sensor provides data on the movement of the wearer. The microsensor(s) 12 can be mounted or attached to any piece of equipment or on the body of a user. The microsensor(s) 12 is preferably similar in size to an American quarter.

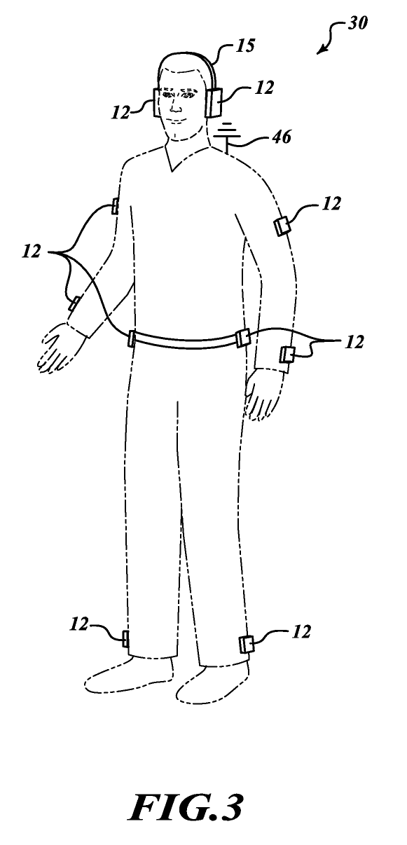

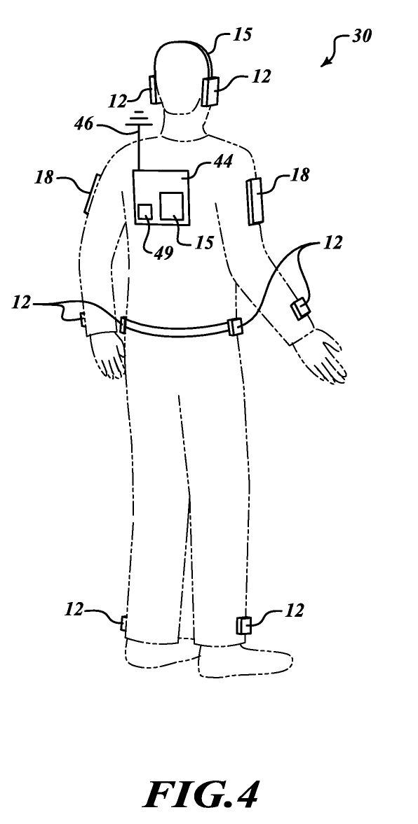

FIG. 3 shows a front view of a human performance augmentation system 30 shown on a person. In one embodiment one or more microsensor(s) 12 are attached to the following but not limited to a helmet or other headgear, a wrist, an elbow pad, a belt, a load carrying vest, body armor, an ankle protector, a knee protector and/or an article of clothing. The microsensor(s) 12 are placed in areas most likely to detect a particular condition. For example microsensor(s) 12 on the head of a user would be practicable for detection of movement, whereas a microsensor(s) on the wrist of a user may be used to determine the health of the user. In one embodiment the microsensor(s) 12 have a built in processor 15, however in an alternate embodiment the microsensor(s) 12 are in communication with the processor 15, using wired or wireless communication. The processor 15 is in communication with the tactile interface 18. The tactile interface 18 includes a number of actuators (not shown) that may be affixed to the skin with an adhesive or optionally integrated into the clothing or armor to allow for close contact with the skin. Additionally, the components of the system are powered by a battery or energy harvesting (solar, thermal, heel-strike, vibration, etc) device (not shown). The person is further wearing a backpack 44, which is further described in FIG. 4.

FIG. 4 shows a rear view of a human performance augmentation system 30 shown on a user. The user is wearing the plurality of microsensor(s) 12, the at least one processor 15, and the tactile interface 18. Further included is an optionally advantageous backpack 44, including a Inertial Navigation System (INS) 49, the processor 4815 and an antenna 46. The processor 15 of the backpack is configured to process the sensed signals from the microsensor(s) 12 as well as transmit, using the antenna 46, sensed information. The signals include but are not limited to: actions of the user; location of the user as determined by the INS 49 via the antenna 46; the activity around the user, etc. The processor 15, via the antenna 46, further sends location information along with any sensed information in order to orient a receiving unit to the location of the sensed information. In one embodiment the receiving unit receives the location of the sending unit and a distance and direction to the sensed information. The receiving unit mathematically triangulates the location of the sensed information by comparing the difference between the sending unit and the receiving unit. The user of the receiving unit is then alerted to the sensed information.

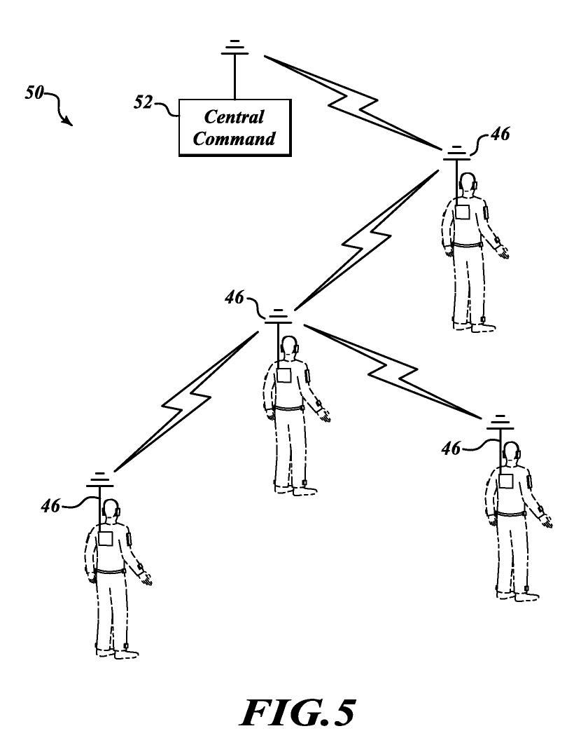

FIG. 5 shows a plurality of users in signal communication using multiple human performance augmentation systems 50. Each user having the plurality of microsensor(s) 12, at least one processor 15, and the tactile interface 18. The processors, through the antenna's 46, are in communication with each other's antenna in a predefined range and are in communication with a command center 52. Each backpack is configured to send and receive sensed information with position information in order to orient all users to the sensed information. For example if one user sensed movement then each related user is alerted to the movement based on their location relative to the sensed movement.

In one embodiment, a user has the human performance augmentation system and is operating in a hostile environment. The user has multiple microsensor(s) including a motion detector and a nuclear, biological, and chemical (NBC) sensor. The NBC sensor identifies a chemical plume at 90° degrees magnetic and 800 meters away. The processor identifies the signal from the sensor and prepares the necessary signal for the tactile interface. The tactile interface, affixed to the user's forearm, is activated and using an array of pressure alerts the user. The tactile interface applies pressure in the magnetic direction of the chemical plume and applies 8 short bursts of pressure to signify the plume is at 800 m. The location and distance will be automatically updated as the user continues to move in space. The user in this case still maintains situational awareness and the ability to use his/her arms, eyes, and ears without being comprised by a loud siren, multiple messages coming across his/her screen/radio and while trying to put on protective gear such as a MOPP suit. If traveling in a squad all users would be notified if a single member of the squad senses a chemical plume.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for human performance augmentation comprising:
collecting sensory data using at least one microsensor attached to a user;
processing at a processor attached to the user the collected sensory data into actionable situational intelligence; and
alerting the user through a tactile interface in communication with the processor, the tactile interface providing stimulation to the user.

2. The method of claim 1, wherein the tactile interface provides multimodal stimulation the user.

3. The method of claim 2, wherein the sensory data further comprises motion detection.

4. The method of claim 3, wherein the sensory data further comprises thermal imaging.

5. The method of claim 4, wherein the sensory data further comprises acoustic sensing.

6. The method of claim 5, wherein the sensory data further comprises detecting the user's health information.

7. The method of claim 6, wherein alerting the user further comprises at least one of applying a vibration, an acceleration, a pressure, a deformation, a temperature, a texture, a timing of a signal, and a viscosity.

8. The method of claim 7, wherein alerting the user further comprises at least one of a varied timing of alerts and a varied array of alerts.

9. A system for human performance augmentation comprising:
at least one microsensor configured to collect sensory data, the microsensor having a processor; and
a tactile interface in communication with the at least one microsensor, such that when altered the tactile interface provides multimodal stimulation to the user.

10. The system of claim 9, further comprising:
at least one tactile interface actuator configured to be affixed to the skin of the user and controlled by the tactical interface.

11. The system of claim 10, wherein sensory data further comprises motion detection.

12. The system of claim 11, wherein sensory data further comprises thermal imaging.

13. The system of claim 12, wherein sensory data further comprises acoustic sensing.

14. The system of claim 13, wherein sensory data further comprises detecting the user's health status.

15. The method of claim 14, wherein alerting the user further comprises at least one of vibration, acceleration, pressure, deformation, temperature, texture, array, timing of a signal, thermal conductivity, and viscosity.

16. A system for human performance augmentation comprising:
means for collecting sensory data;
means for processing the collected sensory data; and
means for haptically notifying a user of the collected sensory data.

17. The system of claim 16, wherein sensory data further comprises motion detection.

18. The system of claim 17, wherein sensory data further comprises thermal imaging.

19. The system of claim 18, wherein sensory data further comprises acoustic sensing.

20. The system of claim 19, wherein sensory data further comprises detecting the user's health status.
